(19) United States
(12) Patent Application Publication
(10) Pub. No.: US 2024/0252919 A1
(43) Pub. Date: Aug. 1, 2024

(54) INFORMATION DISPLAY METHOD, APPARATUS, AND STORAGE MEDIUM

(71) Applicant: Tencent Technology (Shenzhen) Company Limited, Shenzhen (CN)

(72) Inventor: Chunyong CHEN, Shenzhen (CN)

(73) Assignee: Tencent Technology (Shenzhen) Company Limited, Shenzhen (CN)

(21) Appl. No.: 18/632,059

(22) Filed: Apr. 10, 2024

Related U.S. Application Data
(63) Continuation of application No. PCT/CN2023/088452, filed on Apr. 14, 2023.

(30) Foreign Application Priority Data
Sep. 26, 2022 (CN) 202211177429.9

(51) Int. Cl. A63F 13/52; A63F 13/424; A63F 13/533; A63F 13/822; A63F 13/86

(52) U.S. Cl. CPC A63F 13/52; A63F 13/424; A63F 13/533; A63F 13/822; A63F 13/86

(57) ABSTRACT

In an information display method, first gameplay of a game controlled by a player is displayed to a user. Contextual information is determined from the first gameplay of the game. Second gameplay of the game controlled by the user is determined based on the contextual information of the first gameplay of the game. The second gameplay of the game with the first gameplay of the game is displayed. The second gameplay is pre-recorded and the first game play is live-streamed.

### RELATED APPLICATIONS

The present application is a continuation of International Application No. PCT/CN2023/088452, filed on Apr. 14, 2023 and entitled “INFORMATION DISPLAY METHOD AND APPARATUS, DEVICE, STORAGE MEDIUM, AND SYSTEM,” which claims priority to Chinese patent application Ser. No. 20/221,1177429.9, filed on Sep. 26, 2022 and entitled “INFORMATION DISPLAY METHOD AND APPARATUS, DEVICE, STORAGE MEDIUM, AND SYSTEM”. The entire disclosures of the prior applications are hereby incorporated by reference.

### FIELD OF THE TECHNOLOGY

This application relates to the field of Internet technologies, including information display.

### BACKGROUND OF THE DISCLOSURE

With the continuous development of the game industry, game livestreaming, as an influential manner of communication and teaching, has also attracted a lot of attention. Increasingly more people learn how to play games by watching the game livestreaming.

In the related art, a game streamer shares game strategies by explaining while playing games, and users can interact with the streamer via text, speech, or by sending gifts to learn game operations.

However, the foregoing manner of sharing game strategies is rigid and simple.

### SUMMARY

Embodiments of this disclosure include an information display method, apparatus and a non-transitory computer-readable storage medium. Examples of technical solutions in the embodiments of this disclosure may be implemented as follows:

An aspect of this disclosure provides an information display method, performed by a terminal device, for example. In an information display method, first gameplay of a game controlled by a player is displayed to a user. Contextual information is determined from the first gameplay of the game. Second gameplay of the game controlled by the user is determined based on the contextual information of the first gameplay of the game. The second gameplay of the game with the first gameplay of the game is displayed. The second gameplay is pre-recorded and the first game play is live-streamed.

An aspect of this disclosure provides a data processing apparatus, including processing circuitry. The processing circuitry is configured to display first gameplay of a game controlled by a player to a user. The processing circuitry is configured to determine contextual information from the first gameplay of the game. The processing circuitry is configured to determine second gameplay of the game controlled by the user based on the contextual information of the first gameplay of the game. The processing circuitry is configured to display the second gameplay of the game with the first gameplay of the game. The second gameplay is pre-recorded and the first game play is live-streamed.

An aspect of this disclosure provides a non-transitory computer-readable storage medium storing instructions which when executed by a processor cause the processor to perform any of the methods of this disclosure.

The technical solutions provided in embodiments of this disclosure may bring the following beneficial effects:

Two different game videos are displayed on one same screen to facilitate improving a utilization rate of the screen, and prompt information used for displaying a game strategy is displayed during displaying on one same screen, so that a user is enabled to learn the game strategy more intuitively and impressively, thereby facilitating improving a teaching and display effect of the game strategy.

### BRIEF DESCRIPTION OF THE DRAWINGS

FIG. 1 is a schematic diagram of a solution implementation environment according to an embodiment.

FIG. 2 is a flowchart of an information display method according to an embodiment.

FIG. 3 is a schematic diagram of an interface of teaching invitation of a game livestreaming interface according to an embodiment.

FIG. 4 is a schematic diagram of an interface of an operation prompt of a game livestreaming interface according to an embodiment.

FIG. 5 is a schematic diagram of an interface of an operation suggestion of a game livestreaming interface according to an embodiment.

FIG. 6 is a schematic diagram of an interface of skill division of a game livestreaming interface according to an embodiment.

FIG. 7 is a flowchart of an information providing method according to another embodiment.

FIG. 8 is a flowchart of exemplary implementation of an information providing method according to another embodiment.

FIG. 9 is a schematic diagram of implementation of speech recognition according to another embodiment.

FIG. 10 is a schematic diagram of analyzing speech information by using VAD according to another embodiment.

FIG. 11 is a flowchart of decoding speech information according to another embodiment.

FIG. 12 is a block diagram of an information display apparatus according to an embodiment.

FIG. 13 is a block diagram of an information providing apparatus according to another embodiment.

FIG. 14 is a block diagram of a structure of a computer device according to an embodiment.

### DESCRIPTION OF EMBODIMENTS

The objectives, technical solutions, and advantages in embodiments of this disclosure are described in further detail with reference to the accompanying drawings. The described embodiments are some of the embodiments of this disclosure rather than all of the embodiments. Other embodiments are within the scope of this disclosure.

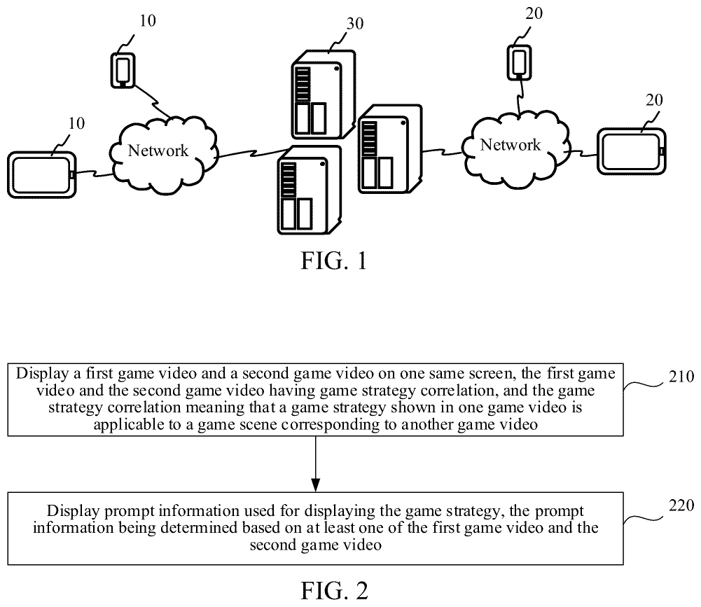

FIG. 1 is a schematic diagram of a solution implementation environment according to an embodiment of this disclosure. The solution implementation environment may be implemented as a computer system for implementing information providing and display functions according to this disclosure. The solution implementation environment may include: a first terminal device 10, a second terminal device 20, and a server 30.

The first terminal device 10 refers to a terminal device used by a first user, and the second terminal device 20 refers to a terminal device used by a second user. The terminal device may be an electronic device such as a mobile phone, a tablet computer, a game console, an e-reader, a multimedia playback device, a wearable device, a Personal Computer (PC), or a vehicle terminal.

In some embodiments, there is a target application running in the second terminal device 20, and the target application has a function of video display. For example, a first game video and a second game video can be displayed on the target application. For example, the target application may be a web browsing program (which is referred to as a browser), a social application, an instant messaging application, a video application, a livestreaming application, a game application, or the like. This is not limited in this disclosure.

The first game video and the second game video are two different game videos. In an embodiment, the first game video may be a livestreaming video, or may be a non-livestreaming video. The second game video may be a livestreaming video, or may be a non-livestreaming video. For a detailed description of the first game video and the second game video, refer to embodiments below.

In some embodiments, using that the first game video is a game livestreaming video of the first user as an example, the game livestreaming video may be provided by the first terminal device 10. There is a game application running in the first terminal device 10. The game application may be an application such as a multiplayer online battle arena (MOBA) game, a shooting game, a racing game, or a strategy game. This is not limited in this disclosure. In addition, the game application or another third-party application has a function of carrying out a real-time online video livestreaming for the game application. By the function, a game livestreaming video can be generated form a game picture of the first user in the game application, then the game livestreaming video is sent to the server 30, and the server 30 sends the game livestreaming video to the second terminal device 20 for display. The foregoing third-party application may be the target application or another application in addition to the target application. The third-party application has a function of obtaining a game picture in the game application to generate a game livestreaming video and sending the game livestreaming video to a back-end server of the target application.

The server 30 may be an independent physical server, or may be a server cluster including a plurality of physical servers, or a distributed system, or may be a cloud server that provides cloud computing services. The first terminal device 10 and the second terminal device 20 each may communicate with server 30. The server 30 is configured to provide background services for the first terminal device 10 and the second terminal device 20. The server 30 may be the back-end server of the target application, and can obtain the first game video from the first terminal device 10 and send the first game video to the second terminal device 20.

FIG. 2 is a flowchart of an information display method according to an embodiment of this disclosure. The method may be performed by a terminal device. For example, the terminal device may be the second terminal device 20 in the foregoing embodiment. In an embodiment, the method may be performed by a client of the target application in the second terminal device 20. The method may include at least one of the following steps 210 and 220.

In step 210, a first game video and a second game video is displayed on one same screen, the first game video and the second game video having game strategy correlation, and the game strategy correlation meaning that a game strategy shown in one game video is applicable to a game scene corresponding to another game video. In an example, first gameplay of a game controlled by a player is displayed to a user. Contextual information is determined from the first gameplay of the game. Second gameplay of the game controlled by the user is determined based on the contextual information of the first gameplay of the game. The second gameplay of the game with the first gameplay of the game is displayed. The second gameplay is pre-recorded and the first game play is live-streamed.

In embodiments of this disclosure, the first game video and the second game video are displayed on one same screen. One-screen display refers to displaying the first game video and also the second game video in a screen of the second terminal device. The first game video and the second game video are in a same display state, and both can be seen by a same user.

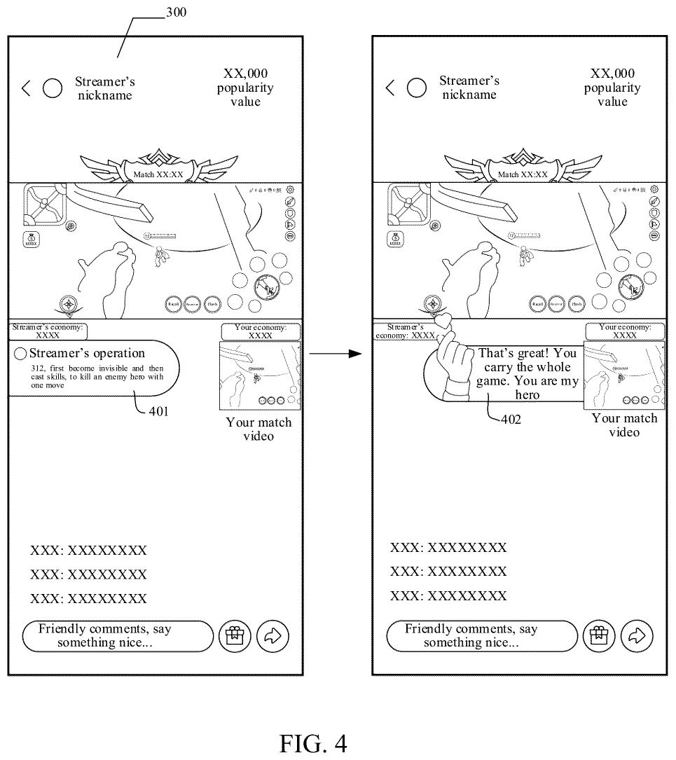

The foregoing one-screen display does not necessarily mean that the first game video and the second game video need to be displayed on the same screen. For example, in a case that the second terminal device has a plurality of screens, for example, the second terminal device is a foldable terminal device having two screens, so that the first game video may be displayed on one screen, and the second game video may be displayed on the other screen. Certainly, the first game video and the second game video may alternatively be displayed on the same screen, for example, displayed in two different areas of the same screen. As shown in FIG. 4, the first game video and the second game video may be displayed on a screen in different sizes, or may be displayed on a screen in the same size, so that the first game video and the second game video do not block each other, and both can be displayed. For example, the first game video and the second game video may both be game livestreaming videos. A server of the target application stores game livestreaming videos recorded in real time by an end user in a game application. A client of the target application of a second user can obtain any two game livestreaming videos in the server of the target application and display the any two game livestreaming videos on one same screen on the client of the target application of the second terminal device.

For example, the first game video and the second game video may both be historical game videos. The server of the target application stores historical game videos of game matches in which the end user has participated. The client of the target application of the second user can obtain any two historical game videos in the server of the target application and display the any two historical game videos on one same screen on the client of the target application of the second terminal device.

For example, the first game video is the game livestreaming video, and the second game video is the historical game video. The client of the target application of the second user can obtain any game livestreaming video and any historical game video in the server of the target application and display the game livestreaming video and the historical game video on one same screen on the client of the target application of the second terminal device.

In some embodiments, the first game video and the second game video are two game videos of different users for the same game. For example, the first game video is a game video of a first user for a first game, and the second game video is a game video of the second user for the first game. For example, the first game video is a game video of the first user for a specific MOBA game named Honor of XX, and the second game video is a game video of the second user for the specific MOBA game name Honor of XX. The first game video of the first user and the second game video of the second user are displayed on one same screen, and game strategies of the two users are compared to achieve a purpose of comparative teaching.

In some embodiments, the first game video is the game livestreaming video of the first user, and the second game video is the historical game video of the second user. The client of the target application of the second user can obtain the game livestreaming video of the first user and the historical game video of the second user in the server of the target application, and display the game livestreaming video of the first user and the historical game video of the second user on one same screen on the client of the target application of the second terminal device, to implement intuitive game strategy teaching by displaying the game livestreaming video and the historical game video on one same screen.

In addition, it may be necessary for the client to obtain a corresponding video stream from the server in real time to display the game livestreaming video. The historical game video may be obtained by the client from the server or stored locally on the second terminal device, and the client obtains the historical game video locally from the second terminal device for display. This is not limited in this disclosure.

For example, the first user may be a streamer user and the second user may be an audience user. During using the game application to carry out a game match process, the streamer user can make real-time video recording of a game picture in the game match process to generate a corresponding game livestreaming video. Certainly, in addition to an image frame corresponding to the game picture, the game livestreaming video may further include corresponding audio information, such as audio information of the game application, as well as audio information generated by speaking of the first user during the game match. The first terminal device can send the game livestreaming video of the first user to the server. The server sends the game livestreaming video of the first user to another terminal device (such as the second terminal device) for display.

The historical game video of the second user refers to a video obtained by recording a game match that the second user participated in during a historical period. For example, the second user can also use the game application to participate in a game match. During a game match, or after the game match, a game picture of the game match process can be recorded to obtain the historical game video. Alternatively, during a game match, or after the game match, a game data file of the game match process can be recorded, and the historical game video showing the game match process can be recovered later by using the game data file. The game data file can record game data of a plurality of timestamps during the game match process. Game data of each timestamp can include related data of each game character participating in the game match, for example, including but not limited to a location, an economic value, an equipment situation, and the like of data. A time interval between adjacent timestamps is not limited in this disclosure. For example, the time interval can be set according to a requirement of a number of frames per second of a recovered video.

In embodiments of this disclosure, the first game video and the second game video are displayed on one same screen. The first game video and the second game video have correlation. In some embodiments, that the first game video and the second game video have correlation means that the first game video and the second game video have game strategy correlation. The game strategy correlation means that a game strategy shown in one game video is applicable to a game scene corresponding to another game video. For example, a game strategy shown in the first game video is applicable to a game scene corresponding to the second game video. A game strategy shown in the second game video can also be applicable to a game scene corresponding to the first game video. Game videos having the game strategy correlation are displayed on one same screen to achieve the purpose of comparative teaching and ensure a teaching effect of comparative teaching.

In some embodiments, that the first game video and the second game video have game strategy correlation includes at least one of the following: The first game video and the second game video correspond to the same game. The first game video and the second game video correspond to the same game character. The first game video and the second game video correspond to the same game mode. The first game video and the second game video correspond to the same game scene. The same game means that a game corresponding to the first game video and a game corresponding to the second game video are the same game, such as the same MOBA game named Honor of XX. The same game character means that a game character corresponding to the first game video (that is, a game character used by the first user in a game match corresponding to the game livestreaming video) and a game character corresponding to the second game video (that is, a game character used by the second user in a game match corresponding to the historical game video) are the same game character, such as the same game character named “Dax” in the same MOBA game named Honor of XX. The same game mode means that a game mode corresponding to the first game video (or a game mode selected by the first user in a game match corresponding to the game livestreaming video) and a game mode corresponding to the second game video (or a game mode selected by the second user in a game match corresponding to the historical game video) are the same game mode, such as the same 5V5 battle mode in a MOBA game, or the same 1V1 battle mode in a racing game. The same game scene means that a game scene corresponding to the first game video (or a game scene selected by the first user in a game match corresponding to the game livestreaming video) and a game scene corresponding to the second game video (or a game scene selected by the second user in a game match corresponding to the historical game video) are the same game scene, such as the same grass scene in a shooting game, or the same track in a racing game. Game videos of the same game (or having the same game character or the same game mode or the same game scene) may be displayed on one same screen to implement comparative teaching and ensure the teaching effect of comparative teaching.

In some embodiments, the historical game video of the second user is displayed on one same screen in response to an operation on a one-screen trigger control during displaying the game livestreaming video of the first user.

The operation on the one-screen trigger control refers to an operation of the second user to trigger a request to display the historical game video of the second user on one same screen. In response to the operation on the one-screen trigger control, the second terminal device transmits a first obtaining request to the server. The first obtaining request is used for requesting to obtain the historical game video of the second user that has the game strategy correlation with the game livestreaming video. The second terminal device receives second video information transmitted by the server. The second video information is used for displaying the historical game video of the second user. The second terminal device displays, based on the second video information, the historical game video of the second user on one same screen during displaying the game livestreaming video of the first user.

For example, the second video information includes a video stream or a video file of the historical game video of the second user. The server sends the video stream or the video file of the historical game video of the second user to the client of the second terminal device to enable the client to display the historical game video of the second user.

For example, the second video information includes a game data file of the historical game video of the second user. Reference may be made to the foregoing embodiments for introduction related to the game data file. Details are not described herein again. The client of the second terminal device can render to generate and display each image frame of the historical game video of the second user based on the game data file.

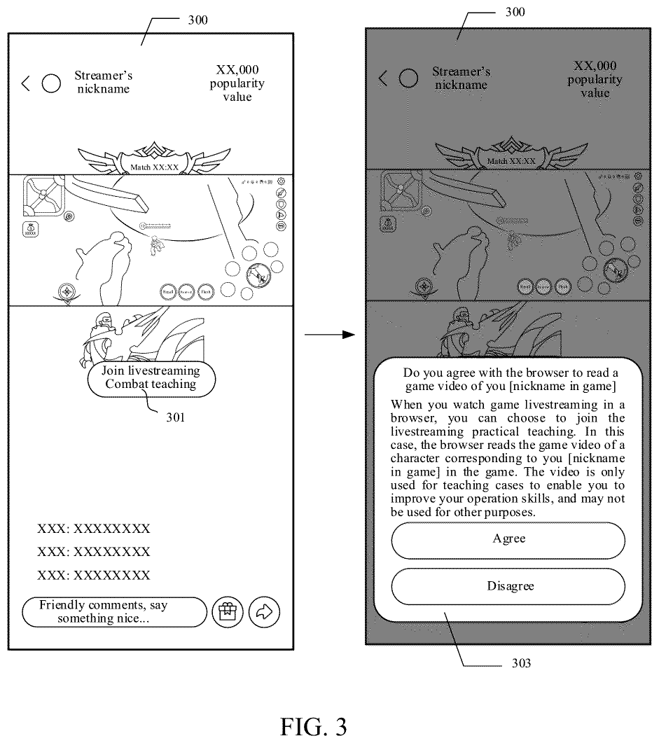

With reference to FIG. 3, after the second user enters the game livestreaming room of the first user, a joining operation on livestreaming combat teaching is performed by the second user using a button 301 for joining livestreaming combat teaching, which is used for triggering acquisition of the historical game video of the second user that has the game strategy correlation with the game livestreaming video of the first user for displaying on one same screen. The second user clicks/taps the button 301 for joining livestreaming combat teaching to trigger the client of the target application to send, to the server, a request for obtaining a game video. The game video that the request requests for obtaining needs to be a historical game video in which the second user has participated in the game application. In addition, the historical game video has specific correlation with the game livestreaming video that the first user is livestreaming.

In an embodiment, in response to the operation on the one-screen trigger control, authorization-confirmation information is displayed. The authorization-confirmation information is used for asking whether a user agrees to related information of the historical game video of the second user being obtained. In a case that an agree indication for the authorization-confirmation information is received, the second terminal device transmits the first obtaining request to the server. Alternatively, if a rejection indication for the authorization-confirmation information is received, the process ends without performing the step of transmitting the first obtaining request to the server.

In some embodiments, the game livestreaming video of the first user is displayed on one same screen in response to an operation on a one-screen trigger control during displaying the historical game video of the second user.

The second user can also perform the operation on the one-screen trigger control when watching the historical game video of the second user, which is used for obtaining the game livestreaming video that has the game strategy correlation with the historical game video for displaying on one same screen. In response to the operation on the one-screen trigger control, the second terminal device transmits a second obtaining request to the server. The second obtaining request is used for requesting to obtain the game livestreaming video that has the game strategy correlation with the historical game video. The second terminal device receives first video information transmitted by the server. The first video information is used for displaying the game livestreaming video of the first user. The second terminal device displays, based on the first video information, the game livestreaming video of the first user on one same screen during displaying the historical game video of the second user.

For example, the first video information includes a video stream of the game livestreaming video of the first user. The server sends the video stream of the game livestreaming video of the first user to the client to enable the client to display the game livestreaming video of the first user.

For example, FIG. 3 is a schematic diagram of a display interface 300 of the game livestreaming video of the first user. The button 301 for joining livestreaming combat teaching can be displayed on the display interface 300. The second user can choose whether to join the livestreaming combat teaching according to a degree of interest in the game livestreaming video of the first user. If the second user, after watching the game livestreaming video of the first user for a period of time, thinks that the first user can bring teaching guidance or help on a game strategy, and wants to learn from the game livestreaming video, the second user can choose to click/tap the button 301 for joining livestreaming combat teaching and join the livestreaming combat teaching in real time. After the second user clicks/taps the button 301 for joining livestreaming combat teaching, the client of the target application displays authorization-confirmation information 303. The authorization-confirmation information 303 is used for asking the second user whether the second user agrees to the historical game video being obtained, and in addition, reminding the second user that an operation of choosing to join the livestreaming combat teaching may cause game data of the second user to be pulled across a program, but the operation of causing the game data to be pulled across the program is used for teaching displayed on one same screen, and does not generate another purpose, and also does not disclose user information of the second user. The second user can choose to agree to grant the target application a right to access related game data in the game application, or choose to refuse to agree to the access of the target application to the related game data in the game application. Only with authorization can the historical game video of the second user be pulled across the program.

According to the foregoing method, a user can enter one-screen display when watching the game livestreaming video, and can also enter the one-screen display when watching the historical game video to learn game operations.

In step 220 prompt information used for displaying the game strategy is displayed, the prompt information being determined based on at least one of the first game video and the second game video. In an example, caption information of game actions performed in at least one of the first gameplay or the second gameplay is displayed during the display of the first gameplay and the second gameplay. The game strategy refers to a game operation mode used by a game user to achieve a purpose of game victory while a game rule is satisfied, and is a thinking mode of the game user when participating in a game process. In embodiments of this disclosure, teaching and display of the game strategy is implemented during displaying the first game video and the second game video on one same screen. Therefore, the prompt information can also be referred to as teaching prompt information, which can play a role in teaching the game strategy. Different games have different game strategies. Using a MOBA game as an example, the game strategy may be when to use a specific skill, how to use a combination of skills to defeat an enemy object, when to build specific equipment, and the like. Using a racing game as an example, the game strategy may be when to brake, when to accelerate, when to use nitrogen, when to use skills, and the like.

In some embodiments, the prompt information is displayed in a case that at least one of the following situations is satisfied:

Situation 1: A comparison result of attribute parameters of a game character in the first game video and a game character in the second game video at a same time point satisfies a first condition.

The foregoing time point refers to a moment when a game match is played, such as 1 minute, and 2 minutes and 40 seconds. The same time point means that a moment when a game match corresponding to the first game video is played and a moment when a game match corresponding to the second game video is played are the same, or a difference between the two moments is less than a first duration. The first duration may be set according to an actual situation, such as 2 seconds and 5 seconds.

The attribute parameter of the game character is used for indicating abilities of the game character in a game match. The attribute parameter of the game character includes, but is not limited to, at least one of an economic value, a kill parameter, a death parameter, a character attribute parameter, and the like. For different games, the attribute parameter of the game character is also different.

The first condition may be set according to the comparison result of the attribute parameters. For example, in a case that the comparison result of the attribute parameters is a difference between the attribute parameters, the first condition may be that the difference between the attribute parameters is greater than a first threshold. For another example, in a case that the comparison result of the attribute parameters is a difference ratio between the attribute parameters, the first condition may be that the difference ratio between the attribute parameters is greater than a first threshold value. It is assumed that there are two attribute parameters A and B. The difference between the attribute parameters is a difference between A and B, such as A−B or |A−B|. The difference ratio between the attribute parameters refers to the difference between the attribute parameters divided by one of the attribute parameters, such as (A−B or |A−B|)/(A or B)./represents a division sign, and |A−B| represents an absolute value of A−B.

The attribute parameters of the game character in the first game video and the game character in the second game video at the same time point are compared. If the comparison result satisfies the first condition, it means that performance of the game character in one party is better than that of the other party, or there is a specific gap in performance of the two game characters. For example, performance of a game character of the first user in the game livestreaming video is better than performance of a game character of the second user in the historical game video. In this case, the prompt information is displayed to enable the second user to intuitively and clearly know good work of the first user and shortcomings of the second user's work, thereby achieving a purpose of learning a game strategy of the first user.

Using a MOBA game as an example, if an economic value of the game character of the first user in the game livestreaming video is significantly higher than an economic value of the game character of the second user in the historical game video at the same time point of a game match, then the prompt information may be displayed. For example, the prompt information enables the second user to know a game strategy of how the first user quickly improving the economic value.

Situation 2: A comparison result of attribute parameters of a game character in the first game video and a game character in the second game video at a same location satisfies a second condition.

The foregoing location refers to a location of the game character in a map provided in the game match. The same location means that a location of the game character in the first game video and a location of the game character in the second game video are the same, or a distance between the two locations is less than a first distance, or the two locations are at a same location range. The first distance may be set according to an actual situation, such as 0.5 meters or 2 meters. The foregoing location range may also be delimited in advance according to an actual need. For example, the entire map is divided into a plurality of plots of the same size. The same location range refers to the same plot. This is not limited in this disclosure.

The attribute parameter of the game character is described above. Details are not described herein again.

The second condition may be set according to the comparison result of the attribute parameters. For example, in a case that the comparison result of the attribute parameters is a difference between the attribute parameters, the second condition may be that the difference between the attribute parameters is greater than a second threshold. For another example, in a case that the comparison result of the attribute parameters is a difference ratio between the attribute parameters, the second condition may be that the difference ratio between the attribute parameters is greater than a second threshold value.

The attribute parameters of the game character in the first game video and the game character in the second game video at the same location are compared to achieve the same effect of prompt in a case that one party performs better.

In an embodiment, Situation 2 and Situation 1 can alternatively be combined. For example, a comparison result of attribute parameters of the game character in the first game video and the game character in the second game video at the same time point and at the same location satisfies a fourth condition. The fourth condition is similar to the first condition and the second condition described above. Details are not described herein again.

Situation 3: A comparison result of attribute parameters of a game character in the first game video and a game character in the second game video in a case of a same economy satisfies a third condition.

The foregoing economy refers to an economic value obtained by the game character in the game match. The economic value can be used for purchasing equipment, vehicles, and other game props. The same economy means that an economic value of the game character in the first game video and an economic value of the game character in the second game video are the same, or a difference between the two economic values is less than a first numerical value, or a difference ratio between the two economic values is less than a second numerical value. The first numerical value may be set according to an actual situation, such as 50 gold coins or 100 gold coins. The second numerical value may also be set according to an actual situation, such as 5% or 10%.

The attribute parameter of the game character is described above. Details are not described herein again.

The third condition may be set according to the comparison result of the attribute parameters. For example, in a case that the comparison result of the attribute parameters is a difference between the attribute parameters, the third condition may be that the difference between the attribute parameters is greater than a third threshold. For another example, in a case that the comparison result of the attribute parameters is a difference ratio between the attribute parameters, the third condition may be that the difference ratio between the attribute parameters is greater than a third threshold value.

The attribute parameters (such as kill parameters, death parameters, and character attribute parameters) of the game character in the first game video and the game character in the second game video in the case of the same economy are compared to achieve the same effect of prompt in a case that one party performs better.

In an embodiment, Situation 3 and Situation 1 can alternatively be combined. For example, a comparison result of attribute parameters of the game character in the first game video and the game character in the second game video at the same time point and in the case of the same economy satisfies a fifth condition. The fifth condition is similar to the first condition and the second condition described above. Details are not described herein again.

In an embodiment, Situation 1, Situation 2, and Situation 3 can alternatively be combined. For example, a comparison result of attribute parameters of the game character in the first game video and the game character in the second game video at the same time point, at the same location, and in the case of the same economy satisfies a sixth condition. The sixth condition is similar to the first condition and the second condition described above. Details are not described herein again.

Situation 4: A game character in the first game video or a game character in the second game video satisfies a determining condition of a highlight moment.

The highlight moment refers to a wonderful moment when a game character performs well during a game match and achieve a great profit. For example, the highlight moment can be a moment when the game character achieves consecutive kills, such as a moment of an instant kill, a moment of killing two or three or more enemy objects, or a moment when the game character makes an important contribution to the team, or a moment when the game character achieves a difficult task. In a case that the game character in the first game video or the game character in the second game video satisfies the determining condition of the highlight moment, prompt information of a corresponding game strategy is generated, so that a highlight moment of the first user can provide operation guidance for the second user. A highlight moment of the second user can praise and encourage the second user, giving the second user more confidence.

Situation 5: A game character in the first game video or a game character in the second game video satisfies a determining condition of an incorrect operation.

The incorrect operation refers to a game operation that a game character has an operation error during a game match, resulting in an adverse consequence. For example, the incorrect operation can be an operation of a wrong sequence of skills, knocking into a wall due to displacement failure, a team fight error, and the like. If the first user has an incorrect operation during a match in game livestreaming, displayed prompt information can show an error of the first user and give a specific suggestion on how to adjust a game operation. If the second user has an incorrect operation during a historical game match, displayed prompt information can be used for prompting the second user to perform a correct game operation.

The prompt information is prompt information that can provide game operation guidance for the second user in real time after game operations in the first game video and the second game video are analyzed and determined, and includes at least one of first prompt information and second prompt information. The first prompt information is used for displaying a game strategy of the first user. The first prompt information includes guidance information when a game operation of the first user is better than a game operation of the second user, for example, when the economic value of the first user is better than the economic value of the second user by a specific difference, and also includes the prompt information of the highlight moment of the first user and reminder information of the incorrect operation of the first user. The second prompt information is used for displaying a game strategy of the second user. The second prompt information includes encouragement information when a game operation of the second user is better than a game operation of the first user, for example, when the economic value of the second user is better than the economic value of the first user by a specific difference, and also includes suggestion information of the game operation of the second user, the praise information of the highlight moment of the second user, and reminder information of the incorrect operation of the second user. Based on the prompt information, a correct operation prompt can be given to the second user, thereby improving an operation level of the second user.

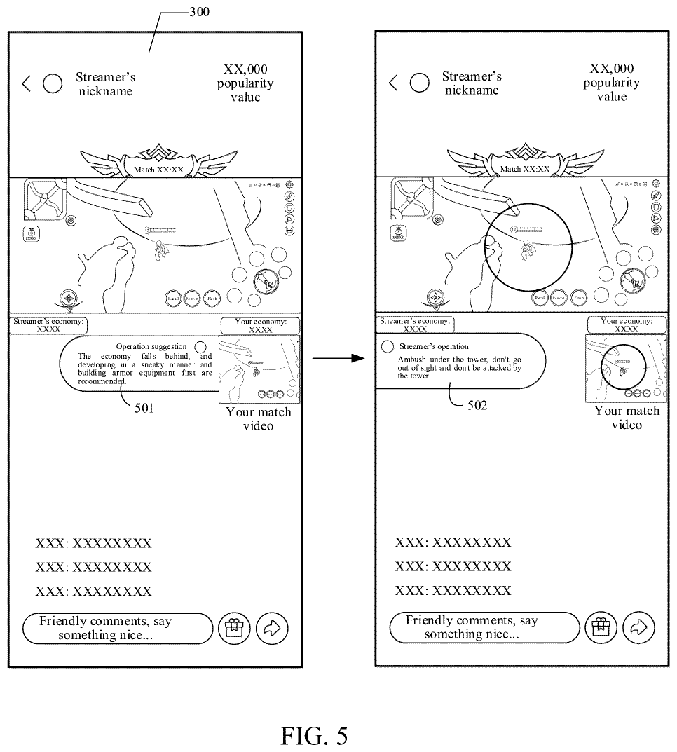

For example, as shown in FIG. 4 and FIG. 5, the economic values of the first user and the second user are displayed on the display interface 300. According to real-time progress of a game, the economic value is also updated and changed as the game progresses.

As shown in FIG. 4, in a case that the first user operates the game character to achieve a highlight moment of an instant kill or killing two or three or more enemy objects, or in a case that game performance of the first user is better than game performance of the second user, an operation prompt card 401 of the first user is displayed on the display interface 300. The first prompt information is displayed in the operation prompt card 401, such as an operation method prompt of the first user to achieve a profit, and is used for guiding the game operation of the second user.

As shown in FIG. 5, in a case that the second user has an incorrect operation during a game, or the game performance of the second user is worse than the game performance of the first user, an operation suggestion card 501 for the second user is displayed on the display interface 300. The second prompt information is displayed in the operation suggestion card 501, and is used for prompting the second user which operation mode is to be used in this situation.

As shown in FIG. 4, in a case that the second user operates the game character to achieve a highlight moment of an instant kill or killing two or three or more enemy objects, or in a case that the game performance of the second user is better than the game performance of the first user, an encouragement card 402 for the second user is displayed on the display interface 300. The second prompt information is displayed in the encouragement card 402, and is used for encouraging the game operation of the second user and enhancing confidence of the second user in operation.

As shown in FIG. 5, in a case that the first user has an incorrect operation during a game, resulting in the first user in a vulnerable situation, an operation instruction card 502 given based on the game operation of the first user is displayed on the display interface 300. The first prompt information is displayed in the operation instruction card 502, and is used for guiding the second user in a game operation mode that can be used to get out of a current game dilemma.

In some embodiments, during displaying the first game video and the second game video on one same screen, game data of the first game video and game data of the second game video are displayed in comparison. The game data includes at least one of the following: an economic value, a kill parameter, a death parameter, and a character attribute parameter. The economic value refers to gold coin profits obtained by killing objects, assisting objects, and the like in each game, and can be used for purchasing game equipment and other props. The kill parameter refers to parameter information of killing a virtual enemy object in a game, and may include the number of times virtual enemy objects are killed and a quantity of assists (which is the number of times allies are assisted to kill the virtual enemy objects). The death parameter refers to parameter information that a virtual object controlled by oneself is killed by the virtual enemy object, and may include a number of deaths of the virtual object controlled by oneself, a success rate of kill, and the like. The kill parameter and the death parameter can be used for determining a game level of a game player. The character attribute parameter refers to numerical values of various attributes of a game character during a game, may include numerical values from different aspects such as a health point, an attack value, and a defense value, and is used for determining a game status of the game character. The game data is compared to intuitively display performance and difference of a user in different game matches, to achieve a teaching effect of comparative teaching.

It is to be added that the game data of the first game video and the game data of the second game video can be obtained from a game data file of the game application, but also from an image frame of a game video picture via an image recognition technology. Data information related to the game data appearing in the image frame of the game picture can be recognized and extracted, so that the data information extracted in real time from the first game video and the second game video can be displayed on one same screen.

An example of a form of a comparative display of the game data on one same screen is not limited in embodiments of this disclosure. For example, the game data of the first game video and the game data of the second game video may be displayed on a screen in the form of numerical value to achieve comparison. As shown in FIG. 3, the economic value of the first game video is displayed below the first game video, and the economic value of the second game video is displayed above the second game video. The one-screen display enables the second user to compare the economic values of the first game video and the second game video in real time. Certainly, in some other embodiments, in addition to being displayed in the form of numerical value, the game data can alternatively be displayed in the form of graph, chart, and the like, to vividly and intuitively show comparative difference between the two pieces of game data.

The game data of the first game video and the game data of the second game video are compared on one same screen. It can be seen that the real-time game level difference between the user of the first game video and the user of the second game video, to enable the second user to learn, based on a level of the game data, an operation part of the game video having a high game level, thereby improving a game operation level of the second user.

For the technical solutions provided in the embodiments, in one aspect, the first game video and the second game video are displayed on one same screen to enable the same user to watch the game operation of the first game video and the game operation of the second game video on one same screen to improve a utilization rate of the screen. That which game operation of each party has deficiencies is analyzed based on the game data of both parties. Therefore, the user can learn, based on a level of the game data, an operation process of the game video having a high game level to improve a game operation level of the user.

In another aspect, in a case that the first game video and the second game video satisfy a prompt condition of the game strategy, for example, in a case that the game data of the first game video and the game data of the second game video reach a specific difference, the prompt information is to be displayed, and can be used for guiding the second user to operate better under a condition of different time, different economies, and different locations during a game, and giving the second user a prompt and a guideline of the game operation in real time. The second user can intuitively see deficiencies in the game operation based on the game data and the prompt information of the first game video and the second game video, and learn effective sub-operations based on the prompt information. Interestingness and interaction of one-screen display of games are improved, and game experience of the second user is enriched, thereby improving a game level of the second user.

In some embodiments, the foregoing method further includes: displaying preview information of at least one video clip, the at least one video clip being from at least one of the first game video and the second game video; playing, in response to a playback operation on a target video clip among the at least one video clip, the target video clip; and synchronously displaying operation division information corresponding to the target video clip during playing the target video clip, the operation division information referring to information of a plurality of sub-operations. In an embodiment, during playing the target video clip, information of a sub-operation corresponding to a picture frame currently displayed in the target video clip is differently displayed from information of another sub-operation.

In some embodiments, the first game video is a game livestreaming video of the first user, and the second game video is a historical game video of the second user. In this case, the at least one video clip may come from the game livestreaming video of the first user. The preview information may be displayed in the form of picture, text, or combination of the picture and the text. This is not limited in this disclosure. The second user can have a general understanding of content of the video clip based on the preview information.

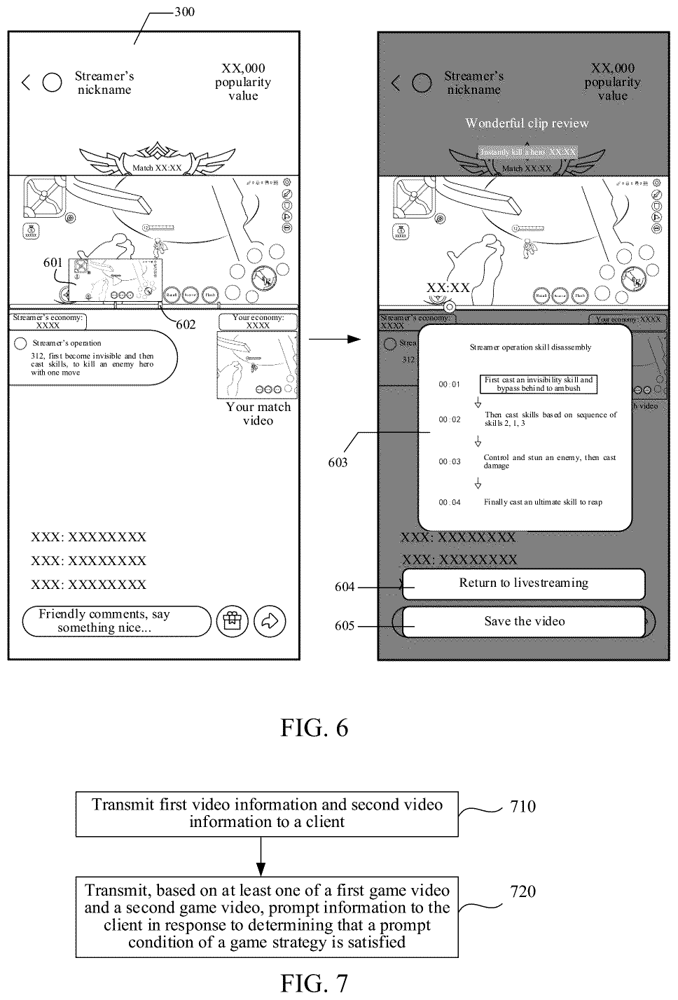

With reference to FIG. 6, a plurality of clip markers 602 having different widths are displayed on a time progress axis of a game livestreaming video displayed on the display interface 300. Each clip marker 602 may represent a video clip. The different widths of the clip markers 602 may be regarded as different lengths of video clips. The video clip is a video clip of a highlight moment of the first user during a previous game operation. A client displays a video preview picture 601 in the video clip presented by the clip marker 602 above the progress axis. The video preview picture 601 is clicked/tapped to watch the video clip. The playback operation on the target video clip among the at least one video clip is performed by the second user by clicking/tapping the video preview picture 601, and is used for playing back the video clip of the highlight moment on the time progress axis. The target video clip refers to a video clip that the second user selects and clicks/taps to watch from the at least one video clip. When the target video clip is played, a skill division card 603 of the target video clip is displayed on the display interface 300. The operation division information of the target video clip is displayed in the skill division card 603. The operation division information refers to specific implementation information of each step when the first user performs the game operation. Each sub-operation corresponds to a video time period of the target video clip. The second user can intuitively see how an operation at a highlight moment is achieved in the first game video and the second game video. During playing the target video clip, when a clip within a time period corresponding to a sub-operation is played, the corresponding sub-operation is to be displayed differently (shown by a box) and distinguished from another sub-operation, so that the second user can clearly recognize a specific implementation of a game operation displayed in a current video. The sub-operations of the target video clip are disassembled to enable the second user to pertinently learn how the game operation at the highlight moment is completed. In addition, during playing the target video clip, information of a sub-operation corresponding to a picture frame currently displayed in the target video clip is differently displayed from information of another sub-operation, so that the second user can clearly know which sub-operation that content displayed in a current picture corresponds to, thereby strengthening memory and improving a teaching effect.

In some embodiments, the client re-displays the first game video and the second game video on one same screen in response to a return operation on the target video clip; or saves the target video clip in response to a saving operation on the target video clip.

The return operation on the target video clip is performed by the second user, and used for continuing to display the first game video and the second game video on one same screen. With reference to FIG. 6, after learning a specific target video clip, the second user can choose to click/tap a button 604 for returning to livestreaming to exit an interface of playing the target video clip, and return to the display interface to continue to watch the first game video or second game video. If the second user thinks that the target video clip needs to be learned or enjoyed again, the second user can choose to click/tap a button 605 for saving a video to save the target video clip to the second terminal device for the second user to watch again. The user can repeatedly watch a video clip of interest to strengthen memory of the video clip and improve the teaching effect.

FIG. 7 is a flowchart of an information providing method according to another embodiment of this disclosure. The method may be executed by a server. For example, the server may be the server of the target application described in the embodiments above. The method may include at least one of the following steps 710 and 720.

Instep 710, first video information and second video information are transmitted to a client, the first video information being used for displaying a first game video of a first user, and the second video information being used for displaying a second game video of a second user; the first game video and the second game video having game strategy correlation, and the first game video and the second game video being displayed on one same screen in the client; and the game strategy correlation meaning that a game strategy shown in one game video is applicable to a game scene corresponding to another game video.

Reference may be made to the foregoing text for introduction related to the first game video and the second game video. Details are not described herein again.

In some embodiments, the first game video is a game livestreaming video of the first user, and the second game video is a historical game video of the second user. If the second user performs an operation on a one-screen trigger control during watching the game livestreaming video of the first user, a client in a second terminal device transmits a first obtaining request to the server. The first obtaining request is used for requesting to obtain the historical game video of the second user that has the game strategy correlation with the game livestreaming video of the first user. Correspondingly, the server receives the first obtaining request transmitted by the client and obtains the second video information from a historical game video library of the second user.

Using a MOBA game as an example, it is assumed that the foregoing correlation indicates the same game and the same game character. After receiving the first obtaining request transmitted by the client, the server first determines a game and a game character (which is denoted as a first game and a first game character) corresponding to the game livestreaming video of the first user, then selects, from the historical game video library of the second user, the first game and a historical game video in which the first game character is used, and obtains corresponding second video information.

In an embodiment, in a case that there are a plurality of historical game videos of the second user that have the game strategy correlation with the game livestreaming video of the first user, the server can send first selection information to the client. The first selection information is used for selecting a historical game video among the plurality of historical game videos. The client displays the first selection information to enable the second user to select a historical game video among the plurality of historical game videos based on the first selection information, and displays the historical game video on one same screen as the game livestreaming video of the first user. The first selection information may include at least one of preview images, preview video clips, text overviews, tag information, game ratings, and game time corresponding to the plurality of historical game videos respectively.

In an embodiment, in the case that there are a plurality of historical game videos of the second user that have the game strategy correlation with the game livestreaming video of the first user, the server may alternatively select, according to a first selection rule, one historical game video among the plurality of historical game videos to provide to the client. The first selection rule may be selecting a video at random, or selecting a video that is closest to current time, or selecting a video having a highest or a lowest rating, and the like. This is not limited in this disclosure.

In some embodiments, the first game video is the game livestreaming video of the first user, and the second game video is the historical game video of the second user. If the second user performs an operation on a one-screen trigger control during watching the historical game video of the second user, a client in a second terminal device transmits a second obtaining request to the server. The second obtaining request is used for requesting to obtain the game livestreaming video that has the game strategy correlation with the historical game video of the second user. Correspondingly, the server receives the second obtaining request transmitted by the client and obtains the first video information from a game livestreaming video library.

Using a racing game as an example, it is assumed that the foregoing correlation indicates the same game and the same game scene (such as the same game map). After receiving the second obtaining request transmitted by the client, the server first determines a game and a game scene (which is denoted as a second game and a second game scene) corresponding to the historical game video of the second user, then selects the second game and a game livestreaming video in which the second game scene is used from the game livestreaming video library, and obtains corresponding first video information.

In an embodiment, in a case that there are a plurality of game livestreaming videos that have the game strategy correlation with the historical game video of the second user, the server can send second selection information to the client. The second selection information is used for selecting a game livestreaming video among the plurality of game livestreaming videos. The client displays the second selection information to enable the second user to select a game livestreaming video among the plurality of game livestreaming videos based on the second selection information, and displays the game livestreaming video on one same screen as the historical game video of the second user. The second selection information may include at least one of preview images, preview video clips, text overviews, tag information, streamer names, and a quantity of livestreaming viewers corresponding to the plurality of game livestreaming videos respectively.

In an embodiment, in the case that there are a plurality of game livestreaming videos that have the game strategy correlation with the historical game video of the second user, the server may alternatively select, according to a second selection rule, one game livestreaming video among the plurality of game livestreaming videos to provide to the client. The second selection rule may be selecting a video at random, or selecting a video having shortest officially start time or shortest livestreaming start time, or selecting a video having a largest quantity of livestreaming viewers or a smallest quantity of livestreaming viewers, and the like. This is not limited in this disclosure.

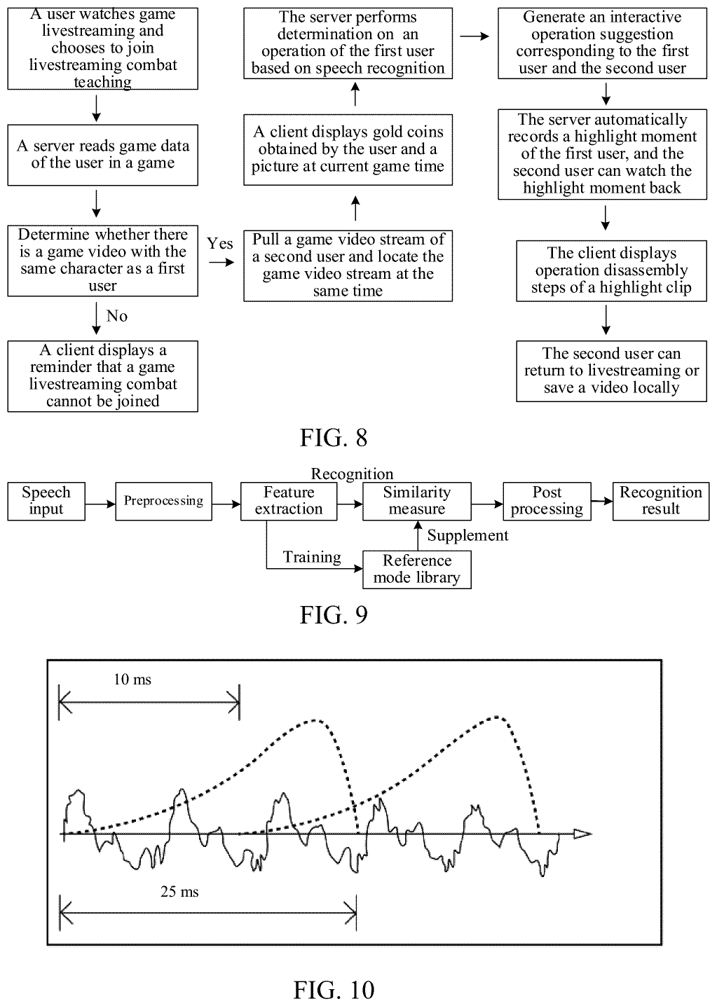

Referring to FIG. 8, in a case that a second user chooses to watch a livestreaming video of a first user on a target application, a client of the target application of a second terminal device sends to a server of the target application, a request for obtaining related information of the game livestreaming video of the first user. The related information of the game livestreaming video includes the game livestreaming video and real-time game data of the game livestreaming video. The first user participates in a game on a game application of a first terminal device and livestreams a real-time game process via a client of a target application of the first terminal device. The client of the target application on the first terminal device performs livestreaming recording on the game application on the first terminal device to obtain the game livestreaming video, including corresponding game data in an embodiment. The client of the target application of the first terminal device sends the recorded game livestreaming video to the server of the target application. After responding to the request to obtain the related information of the game livestreaming video of the first user, the server of the target application sends the game livestreaming video of the first user to the client of the target application of the second terminal device. In this way, the game livestreaming video of the first user can be displayed on the client of the target application of the second terminal device. After the second user chooses to join livestreaming combat teaching, the client of the target application of the second terminal device sends to the server of the target application, a request for the second user to join the livestreaming combat teaching. After responding to the request, the server of the target application sends to a server of the game application, a request for obtaining related information of a historical game video of the second user that has game strategy correlation with the game livestreaming video of the first user.

Referring to FIG. 8, if there is no historical game video in the server of the game application that satisfies a condition in the request, information that there is no historical game video is fed back. If there is a historical game video in the server of the game application that satisfies the condition in the request, related information of the historical game video that satisfies the condition is fed back. In an embodiment, the related information of the historical game video includes the historical game video and game data of the historical game video. The historical game video can be displayed directly on the client of the target application. The game data of the historical game video includes at least one of an economic value, a kill parameter, a death parameter, and a character attribute parameter, and is displayed synchronously with the historical game video on the client of the target application. Alternatively, the related information of the historical game video includes a game data file of the historical game video. The server of the target application needs to render to generate image frames of the historical game video based on the game data file to enable the historical game video to be displayed on the client of the target application. The server of the target application receives feedback information sent by the server of the game application and sends the feedback information to the client of the target application. If the feedback information is that there is no historical game video related to the game livestreaming video, an information reminder of no related video is displayed on a one-screen display interface. On the contrary, the related historical game video and the game livestreaming video of the first user are displayed on the one-screen display interface in one same screen mode. In addition, time progress of the historical game video can be positioned to the same time as the game livestreaming video.

According to the foregoing method, a first game video and a second game video that need to be displayed on one same screen are obtained. Comparative teaching is implemented according to the method of one-screen display to improve a teaching effect.

In some embodiments, if the game livestreaming video and the historical game video are displayed on a screen in different sizes, it is considered that a picture ratio of the game livestreaming video is fixed and unchangeable, for example, may be a picture ratio of 16:9, or may be a picture ratio of 4:3, or may be a picture ratio of 5:4. To be capable of displaying the game livestreaming video and the historical game video on one same screen without affecting full display of teaching prompt information on the one-screen display interface, some non-core pictures of non-game character paths is to be cut out by default, to ensure that a picture of the historical game video displayed on one same screen can show a movement path of a game character and an operation picture when the game character casts a skill.

In addition, game data of the first game video and game data of the second game video are displayed in real time on the one-screen display interface. Refer to FIG. 3 and FIG. 8. The economic value of the first user is displayed below the game livestreaming video, and the economic value of the second user is displayed above the historical game video. This enables the second user to see and compare the economic values of the first user and the second user in real time. The second user can also choose that the historical game video and the game livestreaming video are displayed on one same screen with consistent time of game process, or displayed on one same screen with a consistent location in a map in a game, or displayed on one same screen with a consistent real-time economic value in a game. In this way, the server of the target application can directly position the historical game video to a required video node, and play the historical game video directly from the video node during displaying on one same screen.

In step 720, based on at least one of the first game video and the second game video, prompt information is transmitted to the client in response to determining that a prompt condition of the game strategy is satisfied, the prompt information being used for displaying the game strategy.

As mentioned above, the prompt information includes at least one of the first prompt information and the second prompt information.

In a case that the prompt information includes the first prompt information, the method further includes: determining a game operation of the first user in the first game video; and generating the first prompt information based on the game operation of the first user in a case that the game operation of the first user satisfies a first prompt condition. In combination with an operation of a user in the first game video, the first prompt information having pertinence is generated to improve the teaching effect.

Displaying the first prompt information is displaying the game strategy of the first user during a game, so that the server needs to recognize and determine the game operation of the first user during the game first.

In some embodiments, the determining a game operation of the first user in the first game video includes: obtaining related information of the first user, the related information including at least one of the following: operation information of the first user, speech information of the first user, and an image frame of the first game video; and recognizing and analyzing the related information to determine the game operation of the first user. The operation information of the first user refers to specific sub-operations and operation modes implemented by the first user during a game. The speech information of the first user refers to speech that the first user speaks during a game and is recorded by the server. The image frame of the first game video refers to a collection of image frames included in the first game video. The game operation of the first user in the first game video is represented based on the related information of the first user to better determine whether the game operation of the first user satisfies the first prompt condition.

In some embodiments, in a case that the related information includes the operation information of the first user, a game operation button, a game operation sequence, and a number of game operations triggered by the first user are determined based on the operation information of the first user, and the game operation of the first user is determined based on the game operation button, the game operation sequence, and the number of game operations triggered by the first user. The first user implements different sub-operations and operation modes when implementing a game process. All the sub-operations and operation modes are synchronously uploaded to the server. After receiving the sub-operations and the operation modes of the first user, the server can convert the sub-operations and the operation modes into text information via a language model. The language model is a machine learning model that can convert data information into text content. The data information includes operation information and speech information. The language model can capture data information related to a sub-operation, align corpora between data and text, and perform syntactic analysis, such as relation extraction, entity recognition, dependency syntax, and a phrase structure, to generate text information having natural voice. If the sub-operations of the first user are output in a mode of text information based on the operation information of the first user, a specific operation mode of the first user can be determined based on the game operation button, the game operation sequence, and the number of game operations included in the operation information when the first user implements the sub-operations, to recognize and determine the game operation of the first user. For example, as shown in FIG. 4, text information of current game operations of the first user is “312, first become invisible and then cast skills, to kill an enemy hero with one move”. “312” represents a sequence in which the game character used by the first user casts game skills. In other words, a third skill is cast first, a first skill is cast then, and a second skill is cast after then. “First become invisible and then cast skills, to kill an enemy hero with one move” is the text information generated by the server based on the sub-operations and the operation modes of the first user.

In some embodiments, the speech information of the first user is recognized in a case that the related information includes the speech information of the first user to obtain text content corresponding to the speech information, a keyword related to the game operation is extracted from the text content, and the game operation of the first user is determined based on the keyword. The first user speaks during livestreaming, and spoken content is uploaded to the server synchronously. Some words may be related to the game operation. Therefore, the server recognizes the speech information of the first user and generates corresponding text, extracts, according to semantic analysis, the keyword related to the game operation in the generated text, and combines the operation information of the first user to further recognize and determine the game operation of the first user. For example, refer to FIG. 4. If the first user reminds an ally to become invisible first together with the first user and then cast game skills by speech when communicating with the ally, key information of “become invisible first” and “cast skills” prompted by the first user can be recognized by the server, so that corresponding text information can be generated. In an embodiment, the operation information of the first user can be combined based on recognition of the speech information of the first user to determine the game operation of the first user. For example, for the text information in FIG. 4, after the speech information of “become invisible first” and “cast skills” prompted by the first user is recognized, the sub-operations of the first user can be further determined by combining the game operation button, the game operation sequence, and the number of game operations triggered by the first user.

Refer to FIG. 9. After the speech information is uploaded to the server, the speech information of the first user needs to be preprocessed. As shown in FIG. 10, speech information is analyzed by using voice activity detection (VAD), a silence remove technology. The speech information is divided into frames and cut into small segments. Each segment is referred to as a frame. There is generally an overlap between frames. In addition, silence at the beginning and the end is removed to reduce interference to subsequent steps. Using FIG. 10 as an example, a length of each frame is 25 ms, and there is an overlap: 25−10=15 ms between every two frames. After being divided into frames, the speech information becomes a plurality of small segments. According to physiological characteristics of the human ear, each frame waveform is turned into a multi-dimensional vector for acoustic feature extraction.

In addition, as shown in FIG. 9, feature extraction needs to be performed on the speech information of the first user. The server obtains speech content of the first user in real time, and applies a dynamic time warping (DTW) algorithm to perform speech recognition on the speech content. In other words, the preprocessed and divided-into-frames speech information is compared with a reference speech template to obtain similarity between the speech information and the reference speech template. The reference speech template includes an acoustic feature of sound. A speech information segment of which a feature cannot be extracted is removed to output filtered and effective speech information.

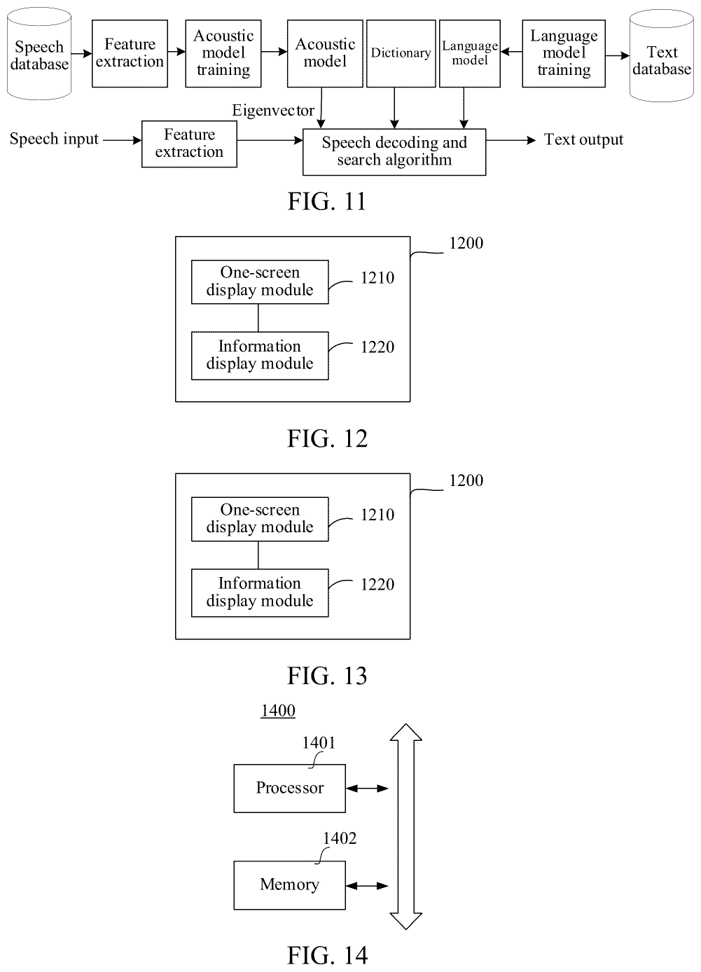

The speech information of the first user is then matched and decoded to generate text. As shown in FIG. 11, in one aspect, similarity-based matching needs to be performed on the speech information after feature extraction and an acoustic feature in a speech database, and the speech information after feature extraction is obtained via an acoustic model. In another aspect, similarity-based matching needs to be performed on the speech information after feature extraction and text information in a text data library, and matched text data is obtained by using a language model and dictionary data. In a case that the content similarity transmitted to the server reaches a specific ratio (for example, in a case that a ratio of the similarity reaches 95%), the text output on the speech information after the extracted features can be performed.

Finally, key content can be intelligently extracted based on the speech information output by the first user in real time. In a case that the key content is extracted, a keyword related to a game operation is extracted, and words having high similarity are analyzed based on semantic analysis. Latent semantic analysis (LSA) is a method used in natural language processing to extract a “concept” from a document and a word via “vector semantic space”, to analyze a relationship between the document and the word. LSA uses a word-document matrix to describe whether a word is in a document. The word-document matrix is a sparse matrix with rows representing words and columns representing documents. Generally, an element of the word-document matrix refers to a quantity of occurrences of the word in the document, or may be term frequency-inverse document frequency (tf-idf) of the word. After the word-document matrix is constructed, LSA performs dimension reduction on the matrix to find a lower-rank approximation of the word-document matrix. A result of dimension reduction is that different words may merge because of semantic correlation of the words, such as: {(car), (truck), (flower)}-->{(1.3452*car+0.2828*truck), (flower)}, dimension reduction may resolve some synonym problems and also resolve some ambiguity problems. For example, after dimension reduction on an original word-document matrix, an ambiguous part corresponding to an original word vector is added to a semantically similar word, while an ambiguous component corresponding to the remaining part is reduced. According to the method, the server can detect the keyword related to the game operation in generated text information.

In some embodiments, the image frame is recognized in a case that the related information includes the image frame of the first game video, and the game operation of the first user is determined, in response to determining and recognizing that the image frame includes a specified interface element, based on the specified interface element. Sound data and video data of the first user participating in a game process are uploaded to the server synchronously. The game video data can be divided into frames to recognize whether a game scene in each picture frame includes the specified interface element. For example, the specified interface element may be celebration information of a highlight moment when a game character achieves consecutive kills. The celebration information is prompt information given by a game application based on an operation effect of the game operation of the first user achieving the consecutive kills. Specified interface elements in consecutive image frames are analyzed to obtain the game operation button, the game operation sequence, and the number of game operations of the first user implementing the game sub-operations, to determine an operation process of the first user reaching the highlight moment, and recognize and determine the game operation of the first user.

For recognition of a game scene in the server, there are mainly two modules: a game client and a computer vision server (CV Server). The game client module is responsible for obtaining image frames in real time from a game application in a first terminal and forwarding the image frames to the CV server. The CV server processes the received game image frames and returns a result to the game client. After further processing according to a requirement, the game client then feeds a final result back to a client of a target application of the second user.

The recognition of a game scene includes recognition of an operation gesture of the first user. A process of determining the game operation button, the game operation sequence, and the number of game operations triggered by the first user is a recognition process of determining a gesture of the first user. For gesture movement information extracted during the gesture recognition process, a gesture image is converted into a hue saturation value (HSV) color space to use chromaticity information of pixels of this space to distinguish hand image content and non-hand image content. This eliminates interference from an environmental factor such as light and background, and an individual difference factor, to greatly improve accuracy of gesture extraction and segmentation. As an extraction method of a gesture feature, a density distribution feature of a gesture target point has invariance of rotation, translation, and scaling. This can reduce an impact of a human factor such as a size of a human hand, difference of an offset between a human hand to a center of a screen, and a distance between a human hand to a gesture acquisition camera on recognition accuracy. As shown in FIG. 8, the first terminal device recognizes a touch sequence formed by a touch position, a touch sequence, and a number of touches of the first user at specified time, corresponds the touch position to a game picture control, and combines recognition of speech information to determine the operation button. Based on the sequence and the number of touches, the game operation of the first user at the specified time can be obtained. The game operation is then processed by the server and sent to the target application of the second terminal device, and presented as prompt information that the second user can see.

In addition, the recognition of a game scene also includes recognition of a game status of the first user. A current status of the first user is determined by recognizing the game status. Each game user interface (UI) is referred to as a game status. A game can be considered to be including many different UIs. To obtain UIs having typical significance in the game application, a sample library of the UIs is established first. In a case that the server obtains an image frame of the first game video in real time, a current image frame can be compared with an image in the sample library of the UIs. If the current image frame belongs to the sample library of the UIs, the current game status of the first user can be determined, for example, a wonderful moment such as an instant kill or killing two or three enemy objects.

According to the foregoing method, the related information of the first user in the first game video is extracted from various aspects to ensure diversity of the related information of the first user, and the game operation of the first user in the first game video is comprehensively described to implement display of the first prompt information, thereby improving a teaching effect.

In some embodiments, the first prompt condition includes at least one of the following: the game operation of the first user matches a pre-stored game operation in a game operation set, the pre-stored game operation being determined based on analysis of a game operation of a target user set; and the game operation of the first user satisfies a determining condition of a highlight moment.

The target user set refers to game users who reach a specific game level or a specific game task level in the game application. The server can analyze game operations of all game users in the target user set, and make statistics on target users corresponding to different types and different modes of game operations, so that target users corresponding to each game operation in the target user set can be obtained. In a case that a ratio of target users corresponding to a game operation exceeds a specific value, the game operation can be classified into a game operation set. In addition, whether the image frame of the first game video includes a specified interface element having celebration information of a highlight moment is recognized to determine whether the game operation of the first user satisfies the highlight moment. If the recognized image frame includes the celebration information indicating a highlight moment, it can be determined that a previous game operation satisfies the highlight moment. On the contrary, it cannot be determined that there is a highlight moment. Based on this, whether a game operation of the first user at a key node (time, a location, an economy) belongs to the game operation set or satisfy the highlight moment is determined in real time. If at least one of the game operation set and highlight moment is satisfied, the game operation of the first user satisfies a first teaching condition, and corresponding prompt information can be generated, such as the operation prompt card 401 in FIG. 4. If any of the foregoing game operation set and highlight moment is not satisfied, no prompt information is generated. If a benefit of the game operation of the first user is lower than that of a specific ratio of game users under big data, the server determines that the first user has an operation error. The one-screen display interface generates a reverse prompt of the first user, such as the operation suggestion card 501 in FIG. 5. The error of the first user is pointed out, and in addition, prompt information of a better strategy is given, to provide the second user with more learning and reference opportunities. According to the first prompt condition, an occasion to display the first prompt information is determined. The first prompt information is displayed in a case that it is suitable for teaching, to improve the teaching effect.

In some embodiments, the generating the first prompt information based on the game operation of the first user includes: obtaining an operation result achieved by the game operation of the first user; and generating the first prompt information based on the game operation of the first user and the operation result.

In a case that the game operation of the first user satisfies the first prompt condition, that is, the game operation of the first user belongs to the game operation set, or the game operation satisfies the determining condition of a highlight moment, the first prompt information can be generated based on the game operation of the first user. The server can first obtain the operation result achieved by the game operation of the first user, such as a game effect of the first user killing a virtual enemy object, a game effect of the first user destroying an enemy field, or a game effect of the first user creating a killing condition for an ally. In an embodiment, the operation result achieved by the game operation of the first user may be obtained from the game data of the first user. For example, a game result of the first user killing an enemy object can be obtained from a kill parameter and a death parameter. The game result can also be obtained from an image frame of the game livestreaming video. For example, the specified interface element can be recognized from the image frame to obtain a game result of the highlight moment of the first user. Reference may be made to the foregoing embodiments for introduction related to recognition and determining of the game operation of the first user. Details are not described herein again. The game operation of the first user and the operation result are output as the first prompt information in a text mode by using a language model. As shown in FIG. 4, refer to the text information “312, first become invisible and then cast skills, to kill an enemy hero with one move” in the operation prompt card 401. Skill prompt information such as “312” can be generated based on sequence of casting skills when the game operation of the first user is recognized. Operation prompt information such as “first become invisible and then cast skills” is generated by recognizing and determining the sub-operations and the operation modes of the first user. Result prompt information such as “to kill an enemy hero with one move” is generated based on the obtained operation result achieved by the game operation of the first user. The game operation of the first user and the operation result are combined to generate the first prompt information such as the text information in the operation prompt card 401. The first prompt information is outputted to enable the second user to learn game sub-operations more intuitively based on the text information.

In some embodiments, the prompt information includes second prompt information, the second prompt information being used for displaying a game strategy of the second user; and the method further includes: determining a game operation of the second user in the second game video; and generating the second prompt information based on the game operation of the second user in a case that the game operation of the second user satisfies a second prompt condition.

The server of the target application displays the first game video and the second game video on the one-screen display interface in one same screen mode, and not only analyzes the game operation of the first game video, but also analyzes the game operation of the second game video simultaneously. Therefore, the game operation in the second game video needs to be determined first. A recognition and analysis method may refer to the recognition and analysis method for the game operation of the first user in the foregoing embodiments. The second prompt condition is similar to the first prompt condition. If the game operation of the second user satisfies at least one of the game operation set and the highlight moment in the first prompt condition, the prompt information can be generated, such as the encouragement card 402 in FIG. 4, giving the second user more confidence in the game operation. On the contrary, if the at least one of the game operation set and the highlight moment is not satisfied, the prompt information is not generated. If a benefit of the game operation of the second user is lower than that of a specific ratio of game users under big data, the server also determines that the second user has an operation error. The one-screen display interface generates a reverse prompt for the second user, such as the operation instruction card 502 in FIG. 5. The error of the second user is pointed out, and a teaching prompt of a current better strategy is given, to enable the second user to master more operation skills based on the prompt information. Based on the second prompt information, the second user can also be taught while the first user is taught.

For the technical solutions provided in the embodiments, the server provides technical support for displaying the first game video and the second game video on one same screen, so that the second user can watch the game operation of the first game video and the game operation of the second game video on one same screen, and analyze that which game operation of each party has deficiencies based on the game data of both parties. In addition, the server determines the game sub-operations and operation modes of the first user by recognizing and analyzing operation information of a game livestreaming picture of the first game video and combining with the extraction and analysis on the speech information of the first user, and transcodes the specific operation information into a text version, thereby generating the prompt information and displaying the prompt information on the one-screen display interface, to provide the second user with a prompt and a guideline of the game operation. Based on the prompt information and real-time changing game data of the first game video and the second game video, the second user can more intuitively understand where the second user needs to improve on the game operation, to pertinently learn various skills on the game operation, thereby improving a game level of the second user.

In some embodiments, at least one video clip is extracted from at least one of the first game video and the second game video; preview information of the at least one video clip is transmitted to the client; a clip obtaining request transmitted by the client is received, the clip obtaining request being used for requesting to obtain a target video clip among the at least one video clip; and the target video clip and operation division information corresponding to the target video clip are transmitted to the client, the operation division information referring to information of a plurality of sub-operations. A user can select a video clip the user wants to watch based on the preview information. The client only needs to obtain the video clip instead of the entire game video, thereby reducing pressure on data transmission between the client and the server.

In some embodiments, the first game video is the game livestreaming video of the first user, and the second game video is the historical game video of the second user. At least one video clip is extracted from at least one of the first game video and the second game video, and the at least one video clip can be extracted from the game livestreaming video of the first user by the server of the target application.

With reference to FIG. 8, in a case that the server of the target application detects a highlight moment of the first user, such as a moment of an instant kill or killing two or three or more enemy objects, the highlight moment may be automatically recorded into a video clip, and prompt information of the highlight moment is transmitted to the client of the target application to generate a corresponding key moment of the highlight clip in the one-screen display interface. In a case that the second user pauses livestreaming, a key moment marker of the highlight moment on a timeline can be seen, such as the clip marker 602 in FIG. 6. In a case that the client of the target application detects that the second user drags to a different key moment marker, the server delivers a preview picture corresponding to a different highlight clip, such as the video preview picture 601 in FIG. 6. The user can click/tap the preview picture to watch the highlight clip in detail. After receiving a request from the client of the target application to obtain the highlight clip, the server disassembles a game operation of the highlight clip corresponding to the preview picture selected by the second user and generates a corresponding text version, and sends the highlight picture and corresponding sub-operation division information to the client of the target application. The second user can watch the highlight clip in full screen. When the second user watches an event of the corresponding video clip, copy information of a game sub-operation corresponding to the event is highlighted for display, so that the user can more clearly review the game operation of the first user. After watching the highlight clip, the second user may choose to save the video clip locally, to facilitate watching and learning for many times later, and the second user may also choose to return to the livestreaming room to continue to watch the game livestreaming video of the first user.

In the foregoing method embodiments, the steps performed by the second terminal device may be independently implemented as an information display method on a terminal device side, and the steps performed by the server may be independently implemented as an information providing method on a server side. In addition, the foregoing embodiments related to a method flow on a second terminal device side correspond to the method embodiments on the server side. For details not explained in detail in one of the embodiments, refer to the introduction in the other embodiment.

Apparatus embodiments of this disclosure are described below, and may be used to perform the method embodiments of this disclosure. For details not disclosed in the apparatus embodiments of this disclosure, refer to the method embodiments of this disclosure.

FIG. 12 is a block diagram of an information display apparatus according to an embodiment of this disclosure. The apparatus has functions of implementing the information display method. The functions may be implemented by using hardware, or may be implemented by hardware executing corresponding software. The apparatus may be a terminal device, or may be disposed in a terminal device. The apparatus 1200 may include: a one-screen display module 1210 and an information display module 1220.

The one-screen display module 1210 is configured to display a first game video and a second game video on one same screen, the first game video and the second game video having game strategy correlation, and the game strategy correlation meaning that a game strategy shown in one game video is applicable to a game scene corresponding to another game video.

The information display module 1220 is configured to display prompt information used for displaying the game strategy, the prompt information being determined based on at least one of the first game video and the second game video.

In some embodiments, the first game video is a game livestreaming video of a first user, and the second game video is a historical game video of a second user.

In some embodiments, the one-screen display module 1210 is configured to:
display the historical game video of the second user on one same screen in response to an operation on one-screen trigger control during displaying the game livestreaming video of the first user;
or
display the game livestreaming video of the first user on one same screen in response to an operation on one-screen trigger control during displaying the historical game video of the second user.

In some embodiments, the prompt information includes at least one of the following:
first prompt information, used for displaying a game strategy of the first user; and
second prompt information, used for displaying a game strategy of the second user.

In some embodiments, the prompt information is displayed in a case that at least one of the following situations is satisfied:
a comparison result of attribute parameters of a game character in the first game video and a game character in the second game video at a same time point satisfies a first condition;
a comparison result of attribute parameters of a game character in the first game video and a game character in the second game video at a same location satisfies a second condition;
a comparison result of attribute parameters of a game character in the first game video and a game character in the second game video in a case of a same economy satisfies a third condition;
a game character in the first game video or a game character in the second game video satisfies a determining condition of a highlight moment; and
a game character in the first game video or a game character in the second game video satisfies a determining condition of an incorrect operation.

In some embodiments, the apparatus 1200 further includes a preview information display module, a video clip playing module, and a division information display module (not shown in FIG. 12).

The preview information display module is configured to display preview information of at least one video clip, the at least one video clip being from at least one of the first game video and the second game video.

The video clip playing module is configured to play, in response to a playback operation on a target video clip among the at least one video clip, the target video clip.

The division information display module is configured to synchronously display operation division information corresponding to the target video clip during playing the target video clip, the operation division information referring to information of a plurality of sub-operations.

In some embodiments, the division information display module is configured to differently display, during playing the target video clip, information of a sub-operation corresponding to a picture frame currently displayed in the target video clip from information of another sub-operation.

In some embodiments, the one-screen display module 1210 is further configured to re-display the first game video and the second game video on one same screen in response to a return operation on the target video clip.

In some embodiments, the apparatus 1200 further includes a video clip saving module (not shown in FIG. 12), configured to save the target video clip in response to a saving operation on the target video clip.

In some embodiments, the first game video and the second game video having game strategy correlation includes at least one of the following:
the first game video and the second game video correspond to a same game;
the first game video and the second game video correspond to a same game character;
the first game video and the second game video correspond to a same game mode; and
the first game video and the second game video correspond to a same game scene.

In some embodiments, the one-screen display module 1210 is further configured to compare and display game data of the first game video and game data of the second game video, the game data including at least one of the following: an economic value, a kill parameter, a death parameter, and a character attribute parameter.

FIG. 13 is a block diagram of an information providing apparatus according to an embodiment of this disclosure. The apparatus has functions of implementing the information providing method. The functions may be implemented by using hardware, or may be implemented by hardware executing corresponding software. The apparatus may be a server, or may be disposed in a server. The apparatus 1300 may include: a video transmission module 1310 and an information transmission module 1320.

The video transmission module 1310 is configured to transmit first video information and second video information to a client, the first video information being used for displaying a first game video of a first user, and the second video information being used for displaying a second game video of a second user; the first game video and the second game video having game strategy correlation, and the first game video and the second game video being displayed on one same screen in the client; and the game strategy correlation meaning that a game strategy shown in one game video is applicable to a game scene corresponding to another game video.

The information transmission module 1320 is configured to transmit, based on at least one of the first game video and the second game video, prompt information to the client in response to determining that a prompt condition of the game strategy is satisfied, the prompt information being used for displaying the game strategy.

In some embodiments, the prompt information includes first prompt information, the first prompt information being used for displaying a game strategy of the first user. The apparatus 1300 further includes a game operation determining module and a prompt information generation module (not shown in FIG. 13).

The game operation determining module is configured to determine a game operation of the first user in the first game video.

The prompt information generation module is configured to generate the first prompt information based on the game operation of the first user in a case that the game operation of the first user satisfies a first prompt condition.

In some embodiments, the game operation determining module is configured to:
obtain related information of the first user, the related information including at least one of the following: operation information of the first user, speech information of the first user, and an image frame of the first game video; and
recognize and analyze the related information to determine the game operation of the first user.

In some embodiments, the game operation determining module is configured to:
in a case that the related information includes the operation information of the first user, determine, based on the operation information of the first user, a game operation button, a game operation sequence, and a number of game operations triggered by the first user, and determine the game operation of the first user based on the game operation button, the game operation sequence, and the number of game operations triggered by the first user;
recognize the speech information of the first user in a case that the related information includes the speech information of the first user to obtain text content corresponding to the speech information, extract a keyword related to the game operation from the text content, and determine the game operation of the first user based on the keyword; and
recognize the image frame in a case that the related information includes the image frame of the first game video, and determine, in response to determining and recognizing that the image frame includes a specified interface element, the game operation of the first user based on the specified interface element.

In some embodiments, the first prompt condition includes at least one of the following:
the game operation of the first user matches a pre-stored game operation in a game operation set, the pre-stored game operation being determined based on analysis of a game operation of a target user set; and
the game operation of the first user satisfies a determining condition of a highlight moment.

In some embodiments, the prompt information generation module is configured to obtain an operation result achieved by the game operation of the first user; and generate the first prompt information based on the game operation of the first user and the operation result.

In some embodiments, the prompt information includes second prompt information, the second prompt information being used for displaying a game strategy of the second user. The apparatus 1300 further includes a game operation determining module and a prompt information generation module (not shown in FIG. 13).

The game operation determining module is configured to determine a game operation of the second user in the second game video.

The prompt information generation module is configured to generate the second prompt information based on the game operation of the second user in a case that the game operation of the second user satisfies a second prompt condition.

In some embodiments, the first game video is a game livestreaming video of the first user, and the second game video is a historical game video of the second user. The video transmission module 1310 is further configured to:
receive a first obtaining request transmitted by the client, the first obtaining request being used for requesting to obtain the historical game video of the second user that has the game strategy correlation with the game livestreaming video of the first user; and obtain the second video information from a historical game video library of the second user; or
receive a second obtaining request transmitted by the client, the second obtaining request being used for requesting to obtain the game livestreaming video that has the game strategy correlation with the historical game video of the second user; and obtain the first video information from a game livestreaming video library.

In some embodiments, the apparatus 1300 further includes a video clip providing module (not shown in FIG. 13), configured to:
extract at least one video clip from at least one of the first game video and the second game video;
transmit preview information of the at least one video clip to the client; receive a clip obtaining request transmitted by the client, the clip obtaining request being used for requesting to obtain a target video clip among the at least one video clip; and
transmit, to the client, the target video clip and operation division information corresponding to the target video clip, the operation division information referring to information of a plurality of sub-operations.

When the apparatus provided in the above-mentioned embodiments implements the functions thereof, only division of the foregoing function modules is used as an example for description. In practical application, the foregoing functions may be allocated to different function modules according to requirements to complete. In other words, the internal structure of a device is divided into different function modules, to complete all or some of the foregoing functions. In addition, the apparatus provided in the foregoing embodiments and the method embodiments belong to the same concept. For examples of details for implementation of the process, reference may be made to the method embodiments. Details are not described herein again.

FIG. 14 is a block diagram of a structure of a computer device 1400 according to an embodiment of this disclosure. The computer device 1400 may be the terminal device described above for implementing the foregoing information display method. Alternatively, the computer device 1400 may be the server described above for implementing the information providing method.

Generally, the computer device 1400 includes a processor 1401 and a memory 1402.

The processor 1401 may include one or more processing cores, for example, a 4-core processor or an 8-core processor. The processor 1401 may be implemented in at least one hardware form among a digital signal processor (DSP), a field programmable gate array (FPGA), and a programmable logic array (PLA). The processor 1401 may further include a main processor and a coprocessor. The main processor is a processor configured to process data in an awake state, and is also referred to as a central processing unit (CPU). The coprocessor is a low power consumption processor configured to process the data in a standby state. In some embodiments, the processor 1401 may be integrated with a graphics processing unit (CPU). The GPU is configured to render and draw content that needs to be displayed on a display. In some embodiments, the processor 1401 may further include an artificial intelligence (AI) processor. The AI processor is configured to process computing operations related to machine learning.

The memory 1402 may include one or more computer-readable storage media. The computer-readable storage medium may be non-transient. The memory 1402 may further include a high-speed random access memory and a nonvolatile memory, for example, one or more disk storage devices or flash storage devices. In some embodiments, the non-transient computer readable storage medium in the memory 1402 is configured to store a computer program, and the computer program is configured to be executed by one or more processors to implement the information display method or implement the information providing method.

A person skilled in the art may understand that the structure shown in FIG. 14 does not constitute a limitation to the computer device 1400, and the computer device may include more components or fewer components than those shown in the figure, or some components may be combined, or a different component deployment may be used.

In an exemplary embodiment, a computer-readable storage medium, such as a non-transitory computer-readable storage medium, is further provided, having a computer program stored thereon, and the computer program, when executed by a processor of a computer device, implementing the information display method or implementing the information providing method. In an embodiment, the computer-readable storage medium may be a read-only memory (ROM), a random access memory (RAM), a compact disc read-only memory (CD-ROM), a magnetic tape, a floppy disk, an optical data storage device, and the like.

In an exemplary embodiment, a computer program product is further provided, including a computer program, and the computer program being stored in a computer-readable storage medium. A processor of a computer device reads the computer program from the computer-readable storage medium. The processor executes the computer program to enable the computer device to perform the information display method, or perform the information providing method.

In an exemplary embodiment, a computer system is provided, including a terminal device and a server, the terminal device being configured to perform the information display method, and the server being configured to perform the information providing method.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

“Plurality of” mentioned in the specification means two or more. “And/or” describes an association relationship for describing associated objects and represents that three relationships may exist. For example, A and/or B may represent the following three cases: Only A exists, both A and B exist, and only B exists. The character “/” generally represents that the associated object is in an “or” relationship. In addition, the step numbers described in this specification merely exemplarily show a possible execution sequence of the steps. In some other embodiments, the steps may not be performed according to the number sequence. For example, two steps with different numbers may be performed simultaneously, or two steps with different numbers may be performed according to a sequence contrary to the sequence shown in the figure. This is not limited in embodiments of this disclosure.

The foregoing disclosure includes some embodiments of this disclosure which are not intended to limit the scope of this disclosure. Other embodiments shall also fall within the scope of this disclosure.

What is claimed is:

1. An information display method, comprising:
displaying first gameplay of a game controlled by a player to a user;
determining contextual information from the first gameplay of the game;
determining, by processing circuitry, second gameplay of the game controlled by the user based on the contextual information of the first gameplay of the game; and
displaying the second gameplay of the game with the first gameplay of the game,
wherein the second gameplay is pre-recorded and the first game play is live-streamed.

2. The method according to claim 1, wherein the determining the second gameplay comprises:
determining the second gameplay from a plurality of pre-recorded gameplays of the user based on the contextual information.

3. The method according to claim 1, wherein the player is a first user and the user is a second user, the second user being different from the first user.

4. The method according to claim 1, wherein the first gameplay and the second gameplay include at least one of
a same game character of the game, a same game mode of the game, a same progress of the game, a same state of the game, or a same game scene of the game.

5. The method according to claim 1, wherein the displaying the second gameplay of the game with the first gameplay of the game comprises:
displaying the second gameplay with the first gameplay in response to a user selection of a control element during the displaying of the first gameplay; and
synchronizing the display of the first gameplay and the display of the second gameplay based on current gameplay information of the first gameplay.

6. The method according to claim 1, further comprising:
displaying caption information of game actions performed in at least one of the first gameplay or the second gameplay during the display of the first gameplay and the second gameplay.

7. The method according to claim 1, further comprising:
displaying caption information of a game operation performed by the player, the game operation being determined based on a keyword extraction from speech information of the player.

8. The method according to claim 6, wherein the caption information comprises:
first caption information indicating a first game strategy of the player that controls the first gameplay; and
second caption information indicating a second game strategy of the user that controls the second gameplay.

9. The method according to claim 6, wherein the caption information of the game actions performed in the at least one of the first gameplay or the second gameplay information is based on a difference between attribute parameters of a game character in the first gameplay and a game character in the second gameplay at the same reference point.

10. The method according to claim 6, further comprising:
comparing first game metrics of the game in the first gameplay and second game metrics of the game in the second gameplay,
wherein the caption information includes an action recommendation based on the comparison of the first game metrics and the second game metrics.

11. A data processing apparatus, comprising:
processing circuitry configured to:
display first gameplay of a game controlled by a player to a user;
determine contextual information from the first gameplay of the game;
determine second gameplay of the game controlled by the user based on the contextual information of the first gameplay of the game; and
display the second gameplay of the game with the first gameplay of the game,
wherein the second gameplay is pre-recorded and the first game play is live-streamed.

12. The data processing apparatus according to claim 11, wherein the processing circuitry is configured to:
determine the second gameplay from a plurality of pre-recorded gameplays of the user based on the contextual information.

13. The data processing apparatus according to claim 11, wherein the player is a first user and the user is a second user, the second user being different from the first user.

14. The data processing apparatus according to claim 11, wherein the first gameplay and the second gameplay include at least one of a same game character of the game, a same game mode of the game, a same progress of the game, a same state of the game, or a same game scene of the game.

15. The data processing apparatus according to claim 11, wherein the processing circuitry is configured to:
display the second gameplay with the first gameplay in response to a user selection of a control element during the display of the first gameplay; and
synchronize the display of the first gameplay and the display of the second gameplay based on current gameplay information of the first gameplay.

16. The data processing apparatus according to claim 11, wherein the processing circuitry is configured to:
display caption information of game actions performed in at least one of the first gameplay or the second gameplay during the display of the first gameplay and the second gameplay.

17. The data processing apparatus according to claim 11, wherein the processing circuitry is configured to:
display caption information of a game operation performed by the player, the game operation being determined based on a keyword extraction from speech information of the player.

18. The data processing apparatus according to claim 16, wherein the caption information comprises:
first caption information indicating a first game strategy of the player of the first gameplay; and
second caption information indicating a second game strategy of the user of the second gameplay.

19. The data processing apparatus according to claim 16, wherein the caption information of the game actions performed in the at least one of the first gameplay or the second gameplay information is based on a difference between attribute parameters of a game character in the first gameplay and a game character in the second gameplay at the same reference point.

20. A non-transitory computer-readable storage medium storing instructions which, when executed by a processor, cause the processor to perform:
displaying first gameplay of a game controlled by a player to a user;
determining contextual information from the first gameplay of the game;
determining second gameplay of the game controlled by the user based on the contextual information of the first gameplay of the game; and
displaying the second gameplay of the game with the first gameplay of the game,
wherein the second gameplay is pre-recorded and the first game play is live-streamed.
